(19) United States
(12) Patent Application Publication
(10) Pub. No.: US 2024/0360377 A1
(43) Pub. Date: Oct. 31, 2024

(54) METHOD AND DEVICE FOR PRESSING A LIQUID EXTRACT OUT OF A MATERIAL TO BE PRESSED

(71) Applicant: Messer SE & Co. KGaA, Bad Soden (DE)

(72) Inventors: Denis Beil, Niederkassel (DE); Frank Gockel, Velbert (DE); Maximilian Rosenberger, Bad Soden (DE)

(73) Assignee: Messer SE & Co. KGaA, Bad Soden (DE)

(21) Appl. No.: 18/565,214

(22) PCT Filed: May 30, 2022
(86) PCT No.: PCT/EP2022/064594

§ 371 Date: Nov. 29, 2023

(30) Foreign Application Priority Data
Jun. 1, 2021 (DE) 10 2021 002 823.6

(51) Int. Cl. C11B 1/06; B01D 11/02; B30B 9/12; C11B 1/10

(52) U.S. Cl. CPC C11B 1/06; B01D 11/0203; B01D 11/0226; C11B 1/104; B30B 9/127

(57) ABSTRACT

A method for pressing a liquid extract out of a material to be pressed. The material to be pressed is supplied to a screw press and is transported along a pressing path in the screw press, and a pressing pressure is applied to the material to be pressed. The screw press is supplied with an extraction agent (e.g., carbon dioxide) which is discharged from the material to be pressed together with the extract. The carbon dioxide is supplied to the screw press in the form of dry ice pellets. The dry ice is mixed with and transported together with the material to be pressed through the screw press along the pressing path. The dry ice is converted into liquid or supercritical carbon dioxide, which dissolves in the extract and reduces the viscosity thereof and which effectively cools the material to be pressed in the screw press.

### CROSS-REFERENCE TO RELATED APPLICATIONS

The present application is the U.S. national stage of international application PCT/EP2022/064594 filed May 30, 2022, which international application was published in the German language on Dec. 8, 2022, as International Publication WO 2022/253749 A1. The international application claims priority to German Patent Application No. 10 2021 002 823.6 filed Jun. 1, 2021. The international application and German application are hereby incorporated by reference herein.

### FIELD

The invention relates to a method for pressing a liquid extract out of a pressing material, in which method the pressing material is fed to a screw press, transported in the screw press along a pressing path and subjected to a pressing pressure, and in which method an extractant is fed to the screw press that is discharged from the pressing material together with the extract, wherein carbon dioxide is used as extractant. The invention also relates to a corresponding apparatus.

### BACKGROUND

In particular, the invention relates to a method and an apparatus for pressing seed. Nowadays, seed such as rapeseeds or sunflower seeds are primarily mechanically pressed to obtain the oil present in the seeds, which in individual cases is also obtained by extraction using a solvent such as hexane or supercritical CO₂. Oil seeds with a high oil content are usually mechanically pressed, since the method is more economical than pure extraction. In particular, screw presses are used for pressing. They enable continuous pressing of the seed. In the process, the seeds are fed to the screw press on an inlet side via a feeding hopper and transported through the pressing chamber by the rotating screw. In a strainer bar-type screw press, the pressing chamber is formed by parallel bars (strainer bars) which are arranged all around the screw with small gaps (strainer cage). Rotation of the screw causes the seed to be pressed against the inner wall of the screw press and the oil can flow off outward through the gaps. The pressing volume narrows toward the outlet end of the screw, with the result that, while the screw is turning, a continuous pressure acts on the mass and oil is pressed out. A largely deoiled press cake leaves the screw at the screw end. However, this largely deoiled press cake usually still has an oil content of 10%-15%, and moreover is rich in proteins. The press cake is generally processed and used as animal feed, and the oil is sold as cooking or industrial oil.

In the past, there were different attempts to reduce the residual oil content of the press cake. One option is to preheat the seed and press it at temperatures above 100° C. (hot pressing). Here, the viscosity of the oil is reduced by the elevated temperature, and more oil can be obtained.

Another approach is to meter supercritical carbon dioxide into the screw press, as is known for example from US 2002/0174780 A or WO 96/33861 A1. In this case, the CO₂ dissolves in the oil, the viscosity of the oil also being reduced, and an elevated oil yield can be observed already at lower temperatures—generally 70° C. to 90° C. In this approach, the screw press has a mechanical pressing section with strainer bars, followed (as seen in the working direction of the press) by a closed section, in which the carbon dioxide is metered in through the outer wall. Following that is another section with strainer bars, in which further oil is removed by virtue of the increase in volume of the carbon dioxide owing to the pressure drop in this section. With this method, it was possible to show that the residual oil content, for example of rapeseeds, can be reduced down to 8-9%. By contrast to hot pressing, this makes it possible to obtain a high-quality oil, since work can be performed at low temperatures.

However, if the aim is to utilize the proteins present in the seeds, the pressing temperatures should be limited to at most 60° C. Moreover, the density of the carbon dioxide in conditions typically prevailing in the screw press, 300-400 bar and 70-90° C., is relatively low; if the temperature in the screw press is reduced, the density of the carbon dioxide used can be considerably increased and thus significantly more CO₂ can be dissolved in the oil.

In order to achieve a pressing temperature of less than 60° C., an attempt that could be made is to further increase the metering of supercritical CO₂, or liquid CO₂, as a result of which the viscosity of the oils would also be reduced further. For example, WO 2008/116457 A1 discloses a pressing method and apparatus in which the pressing material is transported by a screw press along a pressing path and subjected to a pressing pressure. In addition, supercritical carbon dioxide is added to the pressing material as extractant, which is discharged from the pressing material together with the extract. The pressing material is transported along the entire pressing path with a temperature of at most 60° C.

This arrangement, however, is very structurally complex and requires a considerable amount of carbon dioxide to be fed. Moreover, a considerable hardware outlay is necessary to transport liquid or supercritical carbon dioxide at high pressure and introduce it into the screw press, which, as already mentioned above, can have a prevailing pressure of up to 400 bar.

### SUMMARY

The invention is therefore based on the object of specifying a straightforward option for pressing seed in particular, which is highly efficient and makes do with a relatively low hardware outlay.

This object is achieved by an apparatus and/or method having the features recited in the claims.

In a method of the type and specific purpose mentioned in the introduction, according to the invention, therefore, carbon dioxide in the form of dry ice is fed to the screw press and is at least partially transported with the pressing material through the screw press along the pressing path, wherein it is sublimated and at least partially compressed to afford liquid or supercritical carbon dioxide, and in which method the liquid and/or supercritical and/or gaseous carbon dioxide is used as extractant.

The action of the carbon dioxide as extractant according to the invention therefore involves at least one of a number of effects. Firstly, liquid or supercritical carbon dioxide dissolves in the oil where the screw press internal pressure is high enough, reduces its viscosity and removes it through the openings provided in the screw press, for example through gaps or openings in a strainer cage or strainer bars (here also referred to as “extract discharge line”). Secondly, the viscosity of the oil is also reduced by sublimated carbon dioxide gas, which dissolves in the oil. Thirdly, the sublimation of the carbon dioxide leads to an increase in volume, which leads to an intense movement of the carbon dioxide gas produced in the direction of the extract discharge line of the screw press, in the process drawing the oil along with it in a mechanical entrainment effect.

The dry ice is thus fed together with the pressing material to a feeding unit, fed to the screw press and transported through the screw press along the pressing path. In the process, the dry ice sublimates and transforms into the liquid or supercritical state in the high-pressure regions of the screw. The liquid or supercritical CO₂ dissolves in the extract and, together with the latter-driven outward by the pressure gradient—exits the press through the extract discharge line (for example strainer bars). The CO₂ gas also dissolves in the extract, reduces its viscosity and in this way acts as a volume-increasing propellant, which likewise displaces the extract outward through the extract discharge line. Any liquid, supercritical or gaseous carbon dioxide not dissolved in the pressing material likewise exits via the extract discharge line and is removed.

During the pressing operation, the sublimated dry ice transforming into the liquid or supercritical state takes up heat continuously from the pressing material and in this way ensures cooling of the pressing material, which lasts for as long as there are still dry ice particles in the pressing path. This takes place on the one hand over at least a considerable longitudinal extent of the screw press, since the dry ice particles sublimate only gradually. On the other hand, the dry ice particles are also distributed uniformly over the cross section by virtue of being fed together with the pressing material, with the result that the carbon dioxide is well distributed and can act both as coolant and extractant. Therefore, in the case of the invention, CO₂ always intensively penetrates the pressing material from the inside outward, whereas, in the case of arrangements according to the prior art, carbon dioxide is usually metered into the pressing material through the outer wall and good mixing depends on the screw geometry and its mixing behavior.

The lower viscosity of the extract thus causes the yield to increase, and the efficiency of the pressing rises. At the same time, owing to the sublimated dry ice, the pressing material is cooled and thus gently pressed along the entire pressing path. A complex high-pressure feed of liquid or supercritical carbon dioxide to the screw press is therefore unnecessary.

The dry ice is fed to the screw press preferably in the form of carbon dioxide pellets (nuggets) or carbon dioxide snow, either of which can be readily mixed into the pressing material. Preferably, the carbon dioxide pellets or the carbon dioxide snow are/is produced in a pelletizing device or a snow generator in situ from liquid carbon dioxide and fed to a feeding unit of the screw press together with the pressing material immediately after they are/it is produced. The liquid CO₂ used to produce the carbon dioxide particles is stored in a tank, for example at a temperature of −20° C. and a pressure of 20 bar.

The gaseous carbon dioxide produced in the screw press before or during the pressing can be removed and fed for further use. A preferred embodiment provides that the gaseous carbon dioxide is used to render the extract inert. For example, carbon dioxide gas released during the pressing can be fed together with the extract to a collection vessel, in which it forms an atmosphere which keeps out atmospheric oxygen. In particular in the case of readily oxidizing extracts, such as cooking oils, this achieves a further quality improvement.

In an advantageous embodiment of the invention, the temperature in the screw press is continuously measured and the amount of fed dry ice is regulated, in order to not exceed a predefined setpoint temperature in the screw press.

Preferably, the ratio of pressing material and dry ice fed into the screw press is such that the temperature in the screw press is kept below a value of 60° C. For example, for this the amount of pressing material and/or dry ice fed to the screw press can be set variably and is regulated depending on a temperature measured in the screw press, or a means for proportionally metering seed and dry ice is installed. The relatively low temperature of at most 60° C. ensures a particularly low viscosity of the extract and at the same time gentle treatment in particular of pressing materials containing temperature-sensitive substances, such as oil seeds.

An apparatus for pressing a liquid extract out of a pressing material, comprising a screw press, which is equipped with a feeding unit for feeding a pressing material, an extract discharge line for removing extract separated from the pressing material in the screw press, and an outlet conduit for removing the pressing material at least partially freed of the extract from the screw press, is characterized according to the invention in that a feed line for dry ice that is operatively connected to a device for producing dry ice leads into the feeding unit.

Therefore, both the pressing material and carbon dioxide in the form of dry ice, in particular dry ice pellets or carbon dioxide snow, is fed into the feeding unit of the screw press. It preferably comprises a metering device, which can be used to vary the flow rates of product and/or dry ice. The dry ice particles are expediently produced in situ in a conventional pelletizing device, from which the dry ice pellets produced are fed to the metering device of the feeding unit directly or after temporary storage in a buffer vessel. As an alternative or in addition to a pelletizing device, it is also possible for the device used to produce the dry ice to be a snow horn, in which liquid carbon dioxide is expanded to produce carbon dioxide gas and carbon dioxide snow and the carbon dioxide snow produced is then fed to the metering device of the feeding unit.

Upon contact with the pressing material, which is present for example at ambient temperature, some of the dry ice sublimates to afford carbon dioxide gas and in the process cools the pressing material. The feeding unit therefore expediently comprises a feeding hopper, which is closed so as to be substantially impermeable to gas and is fitted with an offgas conduit for removing the carbon dioxide gas produced. The carbon dioxide gas is conducted into the atmosphere via the offgas conduit, fed for further use, such as precooling of the pressing material, or returned to the device for producing dry ice.

The rest of the dry ice enters the screw press together with the pressing material, transforms into the liquid or supercritical state there during the pressing operation, and at least partially dissolves into the extract, as a result of which the viscosity of the extract is reduced and the yield of extract is increased. The carbon dioxide fed in the form of dry ice thus becomes extractant, which promotes the separation of the extract from the rest of the pressing material.

The screw press used is preferably a strainer bar-type screw press. In a particularly advantageous embodiment, the screw press is fitted with closed walls at least in one section, for example front section, through which walls no extract and no carbon dioxide can escape to the outside; it is also possible to provide multiple such sections with completely closed walls along the pressing path which alternate with strainer-bar sections, through which extract or carbon dioxide can exit. The closed wall sections serve to enable the liquid or supercritical carbon dioxide to act on the pressing material and dissolve in the extract to the best possible extent.

The method according to the invention and the apparatus according to the invention are suitable in particular for pressing oil seeds, such as flax, poppies, oilseed rape, soya and/or sunflowers; the invention is, however, not restricted to this application, and instead can for example also be used in environmental technology or chemical industry applications.

### BRIEF DESCRIPTION OF THE DRAWING

An exemplary embodiment of the invention shall be described in more detail on the basis of the drawing. The single drawing schematically shows the circuit diagram of an apparatus according to the invention.

### DETAILED DESCRIPTION

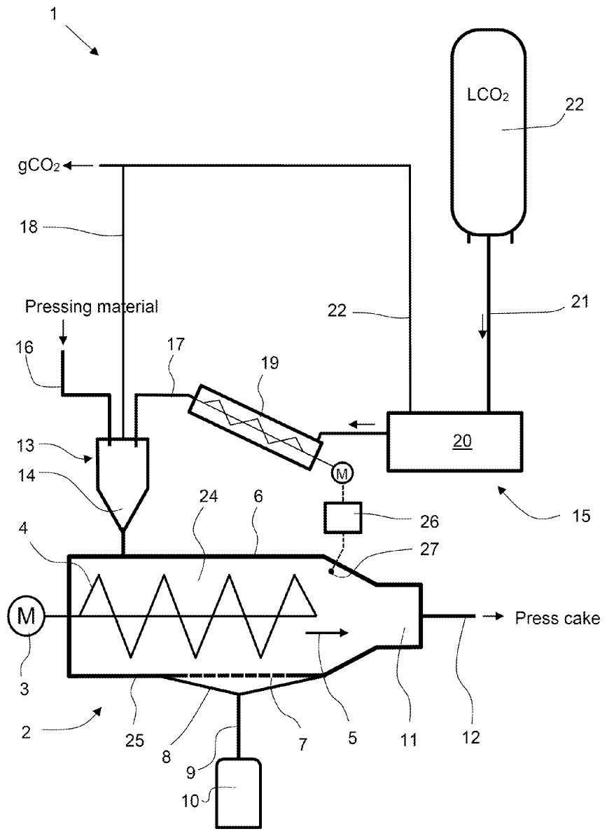

The apparatus 1 shown in FIG. 1 comprises a screw press 2, for example a strainer bar-type screw press. The screw press 2 is equipped with a screw shaft 4 in a manner known per se, the screw shaft being driven by a motor 3 and received in a cylindrical pressing chamber rotatably about its longitudinal axis. The movement of the screw shaft 4 causes a pressing material for treatment to be guided in the direction of the arrow 5 (pressing path) and in the process subjected to an increasing pressing pressure, as a result of which the pressing material is separated into liquid extract and a solid residue (press cake). The walls 6 of the pressing chamber are, as is usual for a strainer bar-type screw press, at least partially formed by mutually parallel bars (strainer bars). Small gaps 7 between or in the strainer bars enable the passage of extract, which is then collected at an extract collector 8 and removed via an extract discharge line 9. The press cake largely freed of extract is removed via an outlet conduit 12 arranged at a press head 11 of the screw press 2.

The apparatus 1 also comprises a feeding unit 13, which leads into the screw press 2 and comprises a feeding hopper 14 leading into the screw press 2. A feed line 16 for the pressing material to be treated, a feed line 17 for dry ice pellets and an offgas conduit 18 for removing carbon dioxide gas lead into the feeding hopper 14, which in all other respects is impermeable to gas and is equipped with thermal insulation.

The feed line 17 is part of a device 15 for producing and transporting dry ice pellets. In addition to the feed line 17, the device 15 comprises a pelletizing device 20, which may be a conventional device for producing dry ice pellets, for example an ASCO dry ice pelletizer A120P. The pelletizing device 20 is connected to a tank 22 for storing liquid carbon dioxide via a carbon dioxide feed line 21. A motor-operated conveying device 19, for example a screw conveyor, makes it possible to convey dry ice pellets produced in the pelletizing device 20 to the feed line 17. As an alternative, the dry ice pellets may also initially be conveyed into a buffer vessel, not shown here, which is connected to a metering screw for further transport to the feeding unit 13.

During operation of the apparatus 1, the pressing material, for example oil seeds, such as oilseed rape, is fed into the feeding hopper 14 via the feed line 16. At the same time, dry ice pellets are produced in the pelletizing device 20. The dry ice pellets are produced from liquid carbon dioxide, which is stored in the tank 22 at low temperatures of for example −20° C. and a pressure of for example 20 bar. The liquid carbon dioxide is fed to the pelletizing device 20 via the feed line 21 and there is first of all expanded to produce carbon dioxide gas and carbon dioxide snow. The carbon dioxide snow is then pressed to afford cylindrical dry ice pellets, which for example have a length between 2 mm and 20 mm, a diameter between 1 mm and 5 mm and a temperature of −78.9° C. The carbon dioxide gas produced when the liquid carbon dioxide is expanded in the pelletizing device 20 is removed via an offgas conduit 22 leading into the offgas conduit 18. The dry ice pellets are fed to the feeding hopper 14 via the feed line 17 by means of the conveying device 19.

In the feeding hopper 14, the pressing material mixes with the dry ice pellets and is cooled in the process. The dry ice pellets partially sublimate and the carbon dioxide gas produced is removed via the offgas conduit 18. The carbon dioxide gas from the offgas conduits 18, 22 can then be fed for further use; for example, the still quite cool gas can be used to precool the pressing material, or it can be reliquefied and returned to the pelletizing device 20 and used therein to produce dry ice pellets.

The cooled pressing material, which is still heavily mixed with dry ice pellets, is then fed to the screw press 2. As a result of the rotation of the screw shaft 4, the pressing material is driven in the direction of the arrow 5 and in the process compressed to pressures of 200 bar to 400 bar in the pressing chamber 24 present between the screw shaft 2 and the walls 6 of the screw press, wherein extract (oil) is separated from the press cake. The extract is forced out of the pressing chamber 24 through the gaps 7, collects in the extract collector 8 and is removed via the extract discharge line 9 and for example collected in a collection vessel 10.

The heat energy input into the pressing material during the pressing operation is partially taken up by the dry ice pellets still present in the pressing material. The amount of dry ice pellets fed through the feed line 17 should be selected such that the temperature inside the screw press 2 does not exceed a predefined value, for example 60° C., at any point during the pressing operation. They sublimate or transform directly into liquid or supercritical carbon dioxide. A separate feed line for liquid or supercritical carbon dioxide going beyond this into the screw press 2 is not necessary in the case of the apparatus 1. The liquid or supercritical carbon dioxide dissolves partially in the extract and reduces its viscosity, as a result of which the yield of extract in the screw press 2 is considerably increased over a procedure without a feed of dry ice pellets. The rest of the liquid or supercritical carbon dioxide, which is not dissolved in the extract, likewise escapes through the gaps 7 and is removed in a manner not shown here. For example, this carbon dioxide can be collected and fed into one of the offgas conduits 18, 22. It may also be drawn off together with the extract via the extract discharge line 9 and—in all other respects also like the carbon dioxide removed via the offgas conduits 18, 22—can be used later on in the procedure to protect the extract against oxidation by atmospheric air, for example in that the carbon dioxide in the collection vessel 10 forms an atmosphere rendering it inert. The press cake which accumulates at the press head 11 and is largely free of extract is removed via the outlet conduit 12 and fed for further use, for example as animal feed.

In the embodiment shown here of an apparatus 1 according to the invention, the walls 6 have a closed form in a front section 25 of the screw press 2, that is to say they have no gaps 7. In this front section 25, it is therefore not possible for extract or carbon dioxide to pass outward; rather, it is used to allow the dry ice converted into liquid or supercritical carbon dioxide to act in the extract and to dissolve into it readily. Such a structure is, however, not imperative according to the invention; for example, it is also possible (not shown here) to provide a first portion—as seen in the working direction of the screw press—having strainer bars which serve for prepressing or pre-deoiling, then there is a closed region (extraction region), in which the dry ice is converted to supercritical carbon dioxide, followed by a further strainer region for oil removal and CO₂ expansion.

The temperature inside the screw press 2 is determined by the ratio of fed pressing material and dry ice. Provided to this end is a control unit 26, which regulates the feed of dry ice pellets via the conveying device 19 on the basis of a temperature measured in the screw press 2 by means of a sensor 27. For example, the feed line 17 is used to feed an amount of dry ice which is sufficient to keep the temperature in the screw press 2 at a predefined setpoint value of, for example, below 60° C. over the entire pressing path.

By feeding dry ice pellets into the screw press 2, the pressing material is cooled and at the same time the yield of extract is increased. In this way, the apparatus 1 enables both gentle and efficient treatment of the pressing material. Moreover, in the case of the apparatus 1 a complex, high-pressure-resistant tube system for feeding liquid or supercritical carbon dioxide is unnecessary.

In all other respects, instead of or in addition to the pelletizing device 20 shown here, it is also possible to use a snow horn, in which liquid carbon dioxide is expanded to form a mixture of carbon dioxide snow and carbon dioxide gas, and the carbon dioxide snow produced in the process is fed into the feeding unit 13 via the conveying device 19 and the feed line 17. The procedure described above with respect to dry ice pellets applies in this case analogously in the same way to the particles of the carbon dioxide snow.

The method according to the invention and the apparatus according to the invention are suitable especially for obtaining oil from oil seeds, such as flax, poppies, oilseed rape, soya and sunflowers.

### LIST OF REFERENCE SIGNS

1. Apparatus
2. Screw press
3. Motor
4. Screw shaft
5. Arrow
6. Walls
7. Gap
8. Extract collector
9. Extract discharge line
10. Collection vessel
11. Press head
12. Outlet conduit
13. Feeding unit
14. Feeding hopper
15. Device (for producing and transporting dry ice pellets)
16. Feed line (for pressing material)
17. Feed line (for dry ice pellets)
18. Offgas conduit
19. Conveying device
20. Pelletizing device
21. Carbon dioxide feed line
22. Carbon dioxide tank
23. -
24. Pressing chamber
25. Front section
26. Control unit
27. Sensor

1. A method for pressing a liquid extract out of a pressing material, in which method:
the pressing material is fed to a screw press, transported in the screw press along a pressing path and subjected to a pressing pressure; and
an extractant is fed to the screw press that is discharged from the pressing material together with the extract, wherein carbon dioxide is used as extractant;
wherein carbon dioxide in the form of dry ice is fed to the screw press, is at least partially transported with the pressing material through the screw press along the pressing path, in the process is sublimated and at least partially compressed to afford liquid or supercritical carbon dioxide, and the liquid and/or supercritical and/or gaseous carbon dioxide is used as extractant.

2. The method as claimed in claim 1, wherein the dry ice is fed to the screw press in the form of carbon dioxide pellets or carbon dioxide snow.

3. The method as claimed in claim 2, wherein the carbon dioxide pellets or the carbon dioxide snow are/is produced on site and fed to a feeding unit of the screw press together with the pressing material immediately after they are/it is produced.

4. The method as claimed in claim 1, wherein gaseous carbon dioxide produced in the screw press before or during the pressing is used to render the extract inert.

5. The method as claimed in claim 1, wherein the temperature in the screw press is continuously measured and the amount of fed dry ice is regulated to maintain a predefined temperature setpoint value.

6. The method as claimed in claim 1, wherein the ratio of pressing material and dry ice fed into the screw press is such that the temperature in the screw press is kept below a value of 60° C.

7. An apparatus for pressing a liquid extract out of a pressing material, the apparatus comprising:
a screw press, which is equipped with a feeding unit for feeding a pressing material, an extract discharge line for discharging extract separated from the pressing material in the screw press, and an outlet conduit for removing the pressing material at least partially freed of the extract from the screw press; and
a feed line for dry ice that is operatively connected to a device for producing dry ice and that leads into the feeding unit.

8. The apparatus as claimed in claim 7, wherein the device for producing dry ice that is used is a pelletizing device for producing dry ice pellets and/or a snow horn for producing carbon dioxide snow.

9. The apparatus as claimed in claim 7, wherein the feeding unit comprises a feeding hopper, which is closed so as to be substantially impermeable to gas and is fitted with an offgas conduit for removing carbon dioxide gas produced in the feeding unit.

10. The apparatus as claimed in claim 7, wherein the screw press used is a strainer bar-type screw press.

11. The apparatus as claimed in claim 10, wherein the screw press is fitted with closed walls at least in one section along the pressing path.

12. The use of a method as claimed in claim 1 for pressing oil seeds, such as flax, poppies, oilseed rape, soya or sunflowers.
